(19) United States
(12) Patent Application Publication
(10) Pub. No.: US 2009/0201133 A1
(43) Pub. Date: Aug. 13, 2009

(54) Method For Enhancing Anti-Cloning Protection of RFID Tags

(75) Inventor: Logan Bruns, Napa, CA (US)

Correspondence Address: LATHROP & GAGE LLP, 4845 PEARL EAST CIRCLE, SUITE 201, BOULDER, CO, 80301, US

(73) Assignee: SKYETEK, INC., Westminster, CO (US)

(21) Appl. No.: 12/327,721

(22) Filed: Dec. 3, 2008

Related U.S. Application Data
(60) Provisional application No. 60/991,877, filed on Dec. 3, 2007.

(51) Int. Cl. H04Q 5/22; G06F 17/30

(52) U.S. Cl. 340/10.1; 707/104.1; 707/E17.044

(57) ABSTRACT

A method for determining validity of an RFID tag. The method includes probing the tag using a series of tag commands to trigger a corresponding series of tag responses, comparing the tag responses to tag reference data stored in a database, and repeating the probing and comparing operations to determine whether or not the tag is valid.

### RELATED APPLICATIONS

This application claims priority to U.S. Provisional Application Ser. No. 60/991,877, filed Dec. 3, 2007, the disclosure of which is incorporated herein by reference.

### BACKGROUND

In the field of RFID technology, a new category of threats has arisen wherein ‘hackers’ or criminals cause valid RFID tags to behave in unexpected (and generally malicious) manners. Typically, computer-bound or mobile RFID readers query RFID tags for their unique identifier or on-tag data, which often serves as a database key or launches some real-world activity. If certain vulnerabilities exist in an RFID system, an RFID tag can be cloned. Tag cloning may allow undesirable operations to be performed, such as delivering counterfeit merchandise under the guise of legitimate products.

### BRIEF DESCRIPTION OF THE DRAWINGS

FIG. 1 is a diagram showing an exemplary RFID tag reading system including a tag reader and an RFID tag in accordance with the present system;

FIG. 2 is a flowchart showing an exemplary set of steps performed in one embodiment of the present system; and

FIG. 3 is flowchart showing an exemplary set of steps performed to construct and subsequently determine tag fingerprints in one embodiment of the present system.

### DETAILED DESCRIPTION

The present method uses RFID tag fingerprinting to help prevent the cloning of tag contents (information stored in the tag) from one tag to another tag. During the fingerprinting process, a tag reader actively probes and/or passively monitors tag interactions to determine tag behavior, and optionally, to measure a number of specific attributes of the tag. The measured tag attributes and behavior are tied to the particular integrated circuit or chip (IC) utilized in the tag and how it is configured. The collection of attribute values and tag behavior constitute a fingerprint of the tag that can be used to identify the tag or that can be included in a digital signature to cryptographically tie the tag's physical attributes to its data contents.

Tag fingerprints are valuable for any tag usage where RFID tag falsification by way of substitution, cloning or blanking is a concern. Common examples of these markets include consumables such printer toner or ink jet cartridges, medical equipment supplies and ski passes. Tag fingerprints provide protection against the cloning of tag contents from one tag to another, and help build confidence in the tag UID (unique identifier) by verifying that the tag IC matches the UID family. This makes it significantly more difficult for a reader-based tag emulation (or other tag ‘spoofing’ mechanism) to pretend to be a fingerprinted tag (otherwise, a reader-based tag emulation could be built out of commodity parts and still conform to the radio protocol and data contents of a particular tag or tag-type).

A wide range of IC and physical attributes may be included in the tag fingerprint. Some attributes may only be measurable with readers having specific hardware. Other attributes are more general. Attributes include specific timing values, protocol values, circuit impedance and other measured tag characteristics bounded by conditions such as frequency or access method. Thus, the same timings may be measured, for example, at different frequencies or under other different operating conditions or different protocol settings.

Tag behavior, on the other hand, may include tag response under different circumstances. For example, a tag may ignore a given formatting error in a protocol message, request a resend, or return an error. In addition, the tag may drop a communication frame or have a bias in the PRNG used for anti-collision.

IC and physical attributes and/or behaviors in a typical tag fingerprint may thus include:
timing characteristics for low level air protocol actions;
various specific protocol values and capabilities;
responses to certain intentional error conditions and off-specification protocol actions;
changes in attributes based on frequency used; and
non-linear characteristics of the IC.

There is a fairly wide range of potential metrics and behaviors that may be included in the tag fingerprinting process. Possible physical attributes include non-modulated impedance versus modulated impedance, relative frequency dependent responses, response harmonics of interest, maps of state diagrams and specific behaviors or responses to various stimulations.

Tag fingerprints bind tag contents to the tag or tag IC family by way of inclusion of the tag fingerprint in the signature that is performed over the tag contents. The tag fingerprint itself may optionally be included in the tag contents, or the fingerprint may be stored externally.

Alternatively, the tag fingerprint may be used by reference, where a detailed tag fingerprint of a given tag (for example, a Rafsec ISO18000-6C (Gen2) UHF tag) is created. Then, instead of including the entire detailed fingerprint in the tag, the tag fingerprint to use is specified by a reference, e.g., “rafsec gen2 ID100” (or implicitly based on some other method of determining the specific tag type) that is external to the tag itself.

The process of constructing the tag fingerprint may include an active probing of the tag to measure and trigger a variety of tag behavior, which includes tag characteristics such as how the tag responds under different circumstances.

A tag may be probed to determine, for example, whether the tag:
ignores a given formatting error in a protocol message;
requests a resend;
returns an error;
drops the frame;
has a bias in the PRNG used for anti-collision; or
behaves properly relative to state diagrams (if any) corresponding to a predetermined tag type.

Alternatively, tag behavior measurement or determination may be a passive determination of attributes during the course of the normal interaction with the tag; i.e., a tag need not be interrogated specifically for the purpose of determining a tag's type or identity. A record of tag behavior may be passively constructed in one process or it may be constructed over time, by monitoring tag responses to commands sent in the normal course of tag interaction with multiple readers. In such a case, a tag will typically be read successively by different readers, and accordingly, data for each tag read is either forwarded to successive readers in a reader network, or stored in a centrally accessible database.

Thus, the tag fingerprint matching need not require an exact match of all attributes of a particular tag, but may instead be based upon a match of some predetermined threshold set of available attributes. Some attributes may not be available via a passive probe or in a time-constrained active probe, or may not be available with certain tag reader hardware.

The following is an example of one possible RFID Tag fingerprint format:

TAG:SELECT(reqa_us=11,lvl1_us=7,lvl2_us=3,lvl3_us=6,rats_us=6,
sak=2420,d
TAG:s=7,dr=7,sym=0,sfgi=6,fwi=2,fsci=4,uid=01020304050607,
two_rats=0)hal
TAG:t(us=6)wake(us=8)transport(ign_blocks=1,small_chain=1,
empty_chains=0
TAG:)DESELECT(us=2)7816(indef=1,def=0,format_a=1,adf=0,
app_1=a3241tag:010)

The example above is a limited example that uses ISO 14443A timings and protocol values. A general format is CATEGORY(ATTRIBUTE=value, . . . ). Thus, for example, lvl2_us is the normalized timing range for the level2 cascade response during select.

To better explain the classes and fields, a specific example of an NXP iCode SLI SL2 1 Kbit ISO15693 tag partial fingerprint is presented:

TAG:INVENTORY(SEL_US=281,SEL_FLAGS=00,DSFID=00,UID=952d1f
06000104e0,AFI_{—}
TAG:O=0,RFU_IGNORED=0,OPTS_IGNORED=0)FRAME(BASE_ETU_N
S=9439,ETU_STEP_NS
TAG:=9,MIN_ETU_NS=9260,MAX_ETU_NS=9911)

In this example, two classes of tests have been run, an ‘inventory’ test suite and a ‘frame’ test suite. The inventory test suite shows that the tag responds to the inventory command under specific conditions in 281 microseconds (SEL_US=281). During this test, the conditions included (1) the flags were clear (SEL_FLAGS), (2) the DSFID was not returned during this test, (3) the UID returned was as shown, (4) this tag does not support responding to an AFI of zero (AFI_O), (5) this tag does not ignore invalid RFU flags settings (RFU_IGNORED), and (6) this tag does not ignore invalid options (OPTS_IGNORED).

During the frame testing the minimum elementary time unit (ETU) that the tag supports was determined to be 9.260 microseconds (MIN_ETU_NS) and the maximum was determined to be 9.911 microseconds (MAX_ETU_NS). For the sake of fingerprint normalization and matching it is noted that the base ETU that perturbation was started from was 9.439 microseconds (BASE_ETU_NS) and that steps of 9 nanoseconds (ETU_STEP NS) were used.

The fingerprint results for this tag type are the inventory response time (281 microseconds) and the ETU (9.260 to 9.911 microseconds). Note that the specific classes of tests, the individual tests, and the results are highly dependent on the tag protocol and command support.

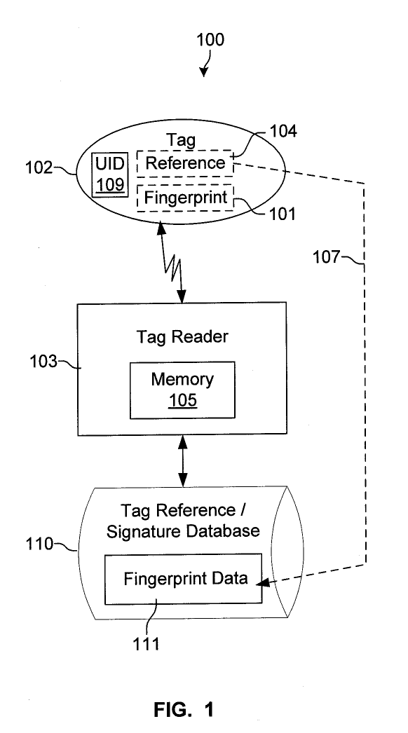

FIG. 1 is a diagram showing an exemplary RFID tag reading system 100 including a tag reader and an RFID tag in accordance with the present system. As shown in FIG. 1, tag reader 103 includes memory 105, which may be used for storing information read from RFID tag 102, including tag fingerprint 101.

RFID tag 102 may contain either a fingerprint 101, or a reference 104 to associated fingerprint data 111 stored in a tag reference/signature database 110 via communications link 107. Tag 102 typically also contains a UID 109, which provides a mechanism for uniquely identifying the tag.

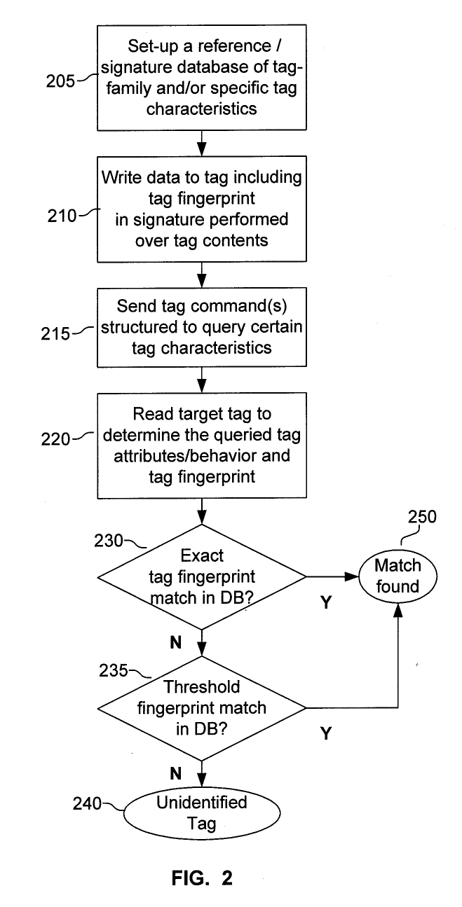

FIG. 2 is a flowchart showing an exemplary set of steps performed in one embodiment of the present system. As shown in FIG. 2, at step 205, a reference database 110 is set up to contain reference data including tag and/or tag-family characteristics. For example, the tag/tag family characteristics may be set up as a tree of attributes and values using data structures and/or state diagrams or the like, representing tag behavior. Since the reference data in reference/signature database 110 is not restricted solely to attributes, state machine graphs may also be stored in the database, to differentiate some tags. Then, a subset (e.g., timings or specific response data) of the attributes may be attached to portions of the applicable graphs. These state machine graphs may be used to determine the behavior of a particular type of tag, as described below.

Reference database 110 may include two types of tag identifying information, either (1) a set or subset of all known metric test results for a given grouping of tags, or (2) a set of normalization rules with appropriate tag version information. For the first tag type, a grouping of tags can be hierarchical. For example, it may be known that in reality there are two different IC revisions that have been sold indiscriminately under the same ostensibly unique product label. For the second type of tag, a set of normalization rules with appropriate version information is included in the tag identifying information. It is highly desirable to normalize the values from the test results. In some cases this normalization process may use multiple available metrics as input to give a more reliable measure for the normalized fingerprint which should be invariant for a given IC type despite inherent variations due to environmental conditions.

At step 210, data is written to tag(s) 102, including the tag fingerprint 101 in the signature that is performed over the tag contents. The tag fingerprint reference type may be included as input to a signature algorithm when signing a tag. The fingerprint reference type may be a complete description including applied normalization rules, version information and normalized fingerprint values, or it can simply be high level data (such as a specific manufacturer's implementation of a 1 k 15693 tag). In the latter case, current rules will be used to establish the veracity of the tag's manufacturer claim. In addition, the cryptographic signature may also include the asserted attributes of the tag such as the UID.

Optionally, the fingerprint may be computed at tag signing. Alternatively, a full raw fingerprint may be computed and used. The latter operation may be performed in the case of an hereto unknown tag implementation. The former operation maybe employed to ensure that tag is not a previously unencountered IC version of a known IC type. Optionally, a new tag fingerprint may be submitted to a local or remote database for future use. In a further option, in the case of normalized fingerprints, multiple normalized fingerprints may be included using different rules in anticipation of different capabilities that may be available at verification time due to varying hardware or in some cases limited reader exposure to the tag (where not all metrics may be obtained.)

At step 215, tag command(s) structured to query certain tag characteristics/tag behavior are sent to a target tag 102 to verify the tag. Tag fingerprint 101 is also read from the tag, or alternatively, if the tag fingerprint is located in database 110 rather than on the tag itself, the tag reference 104 is read, instead. When verifying a tag, either (1) the normalized fingerprint (fingerprint description including normalized values and normalization rules and version information) will be read off the tag and verified, or (2) the high level data will be read and suitable fingerprinting process will be applied to enforce the constraint. As previously mentioned, either the fingerprint description or constraint in addition to the tag's asserted attributes will be included in the cryptographic signature.

At step 220, tag 102 is read by reader 103 to determine the queried tag characteristics/behavior. At step 230, database 110 is checked to determine whether an exact tag fingerprint match found. If an exact match is found, the tag 102 and the tag contents are considered to be valid and not cloned, at step 250. If an exact match is not found, at step 235, then a determination is made as to whether a threshold fingerprint match exists. If so, the tag and the tag contents are considered to be valid, at step 250. If neither an exact nor a threshold fingerprint match is found, then the tag is considered to be of an unidentified type, or possibly cloned, at step 240.

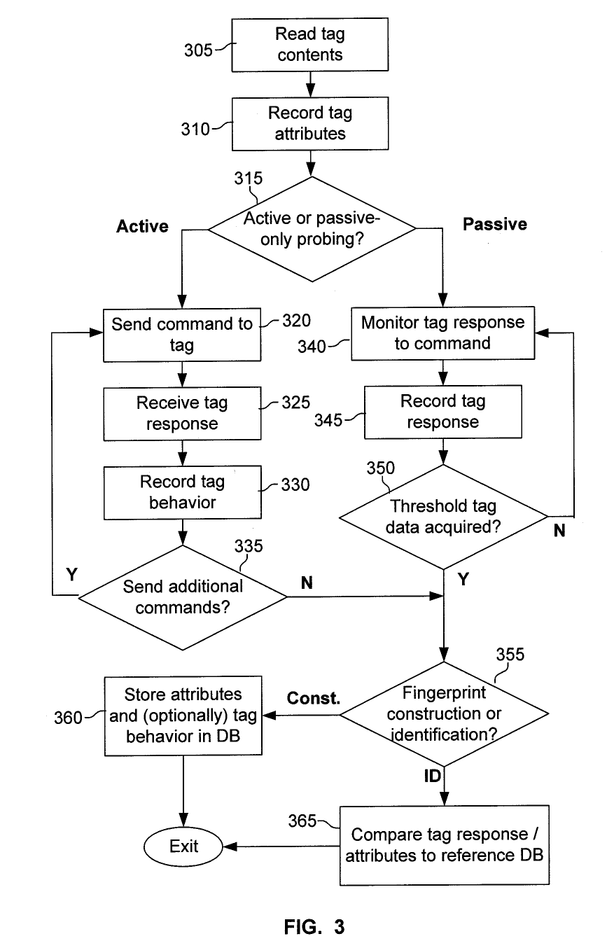

FIG. 3 is flowchart showing an exemplary set of steps performed to construct and subsequently determine tag fingerprints 101 in one embodiment of the present system. As shown in FIG. 3, at step 305, contents of tag 102, including either tag fingerprint 101 or tag reference 104, are read by an RFID tag reader 103. At step 310, tag attributes within the tag contents are recorded in tag reader memory 105.

The present method differentiates active and passive fingerprinting (step 315). In an exemplary embodiment, fingerprint matching is performed based on a threshold of matched attributes or minimally based on the subset available rather than an exact match each time. In some cases such as fingerprint creation, or when risk of cloning is high, an active approach may be undertaken that may require a significant amount of probing. This active approach to tag matching is shown in steps 320-335 of FIG. 3.

As indicated in step 320, a command, which may be determined by a state diagram associated with the tag fingerprint, is sent from tag reader 103 to a target tag 102 for the specific purpose of actively probing the tag to determine its fingerprint. The tag response is then received by reader 103 at step 325. At step 330, the tag behavior is then recorded in tag reader memory 105. A check is then made at step 335 to determine whether additional commands/responses are required to establish the target tag's identity. If so, steps 320-330 are then repeated until a sufficient number of responses are received from the tag, at which time tag processing continues at step 355, described below.

In relatively low risk situations, a passive approach may be used to accumulate attributes and behavior data for tag matching. This passive matching approach is shown in steps 340-350 of FIG. 3. As indicated in step 340, normal communication from the target tag 102 is monitored by tag reader 103 and recorded in reader memory 105, at steps 340/345, until it is determined, at step 350, that a threshold set or a minimum available subset of tag data has been acquired.

A history of tag behavior may be accumulated from successive responses received by different tag readers. For example, where a particular tag travels past a series of networked readers, a store-and-forward technique may be employed wherein each reader in a distribution chain records local responses from the tag and sends those responses, as well as any responses received from a downstream reader, to the next (upstream) reader in the chain.

Alternatively, or additionally, physical tag attributes (e.g., timing and/or impedance) may be measured to the extent that it is possible to distinguish between tags having the same ICs. This is possible due to inevitable minor differences introduced during the tag manufacturing process.

At step 355, depending on whether the current process is one of fingerprint construction or fingerprint determination, corresponding step 360 or step 365 is respectively performed. In step 360, fingerprint construction is completed by storing tag attributes and (optional) tag behavior in reference/signature database 110. In step 365, fingerprint identification is completed by comparing target tag response/attributes to those stored in the reference/signature database 110 to determine target tag validity or invalidity and/or potential tag cloning.

Certain changes may be made in the above methods and systems without departing from the scope of that which is described herein. It is to be noted that all matter contained in the above description or shown in the accompanying drawings is to be interpreted as illustrative and not in a limiting sense. For example, the methods shown in FIGS. 2 and 3 may include steps other than those shown therein, and the systems and structures shown in FIG. 1 may include different components than those shown in the drawing. The elements and steps shown in the present drawings may be modified in accordance with the methods described herein, and the steps shown therein may be sequenced in other configurations without departing from the spirit of the system thus described. The following claims are intended to cover all generic and specific features described herein, as well as all statements of the scope of the present method, system and structure, which, as a matter of language, might be said to fall therebetween.

What is claimed is:

1. A method for determining validity of an RFID tag comprising:
probing the tag using a series of tag commands to trigger a corresponding series of tag responses;
comparing the tag responses to tag reference data stored in a database;
repeating the steps of probing and comparing to determine the validity of the tag.

2. A method for determining validity of an RFID tag comprising:
storing, in a reference database, a tag fingerprint including attributes for a specific type of RFID tag;
including the tag fingerprint in contents stored in a specific RFID tag;
reading the contents stored in a selected RFID tag;
determining whether the selected RFID tag is a valid specific type of RFID tag by comparing the tag fingerprint in the contents read from the selected RFID tag with the attributes for the specific type of RFID tag stored in the reference database.

3. The method of claim 2, wherein, when the comparing step does not result in an exact match between the attributes being compared, then:
determining whether the selected RFID tag is a valid specific type of RFID tag based on a comparison of a predetermined threshold set of available attributes, read from the selected RFID tag, with the attributes, for the specific type of RFID tag, stored in the reference database.

4. The method of claim 3, wherein said attributes for the specific type of RFID tag include at least one attribute selected from the list of attributes consisting of specific timing values for protocol actions, off-specification protocol actions, tag circuit impedance, responses to certain intentional error conditions, changes in said attributes based on tag communication frequency, and non-linear circuit characteristics of the tag.

5. A method for determining validity of an RFID tag comprising:
storing, in a reference database, a tag fingerprint including attributes for a specific type of RFID tag, wherein the tag behavior comprises responses, from the tag, to a specific sequence of commands sent to the tag;
including the tag fingerprint in a digital signature performed over contents stored in a specific RFID tag;
reading a selected RFID tag; and
determining whether the selected RFID tag is a valid specific type of RFID tag by comparing the tag fingerprint in the contents read from the selected RFID tag with the attributes, for the specific type of RFID tag, stored in the reference database.

6. The method of claim 5, further comprising:
storing, in the reference database, a tag fingerprint including indicia of tag behavior indicative of the specific type of RFID tag; and
comparing the tag behavior of the selected tag with the indicia of tag behavior, for the specific type of RFID tag, stored in the reference database.

7. The method of claim 5, wherein said attributes include at least one attribute selected from the list of attributes consisting of specific timing values for protocol actions, off-specification protocol actions, tag circuit impedance, responses to certain intentional error conditions, changes in said attributes based on tag communication frequency, and non-linear circuit characteristics of the tag.

8. The method of claim 5, wherein, when the comparing step does not result in an exact match between the attributes being compared, then:
determining whether the selected RFID tag is a valid specific type of RFID tag based on a comparison of a predetermined threshold set of available attributes, read from the selected RFID tag, with the attributes, for the specific type of RFID tag, stored in the reference database.

9. A method for determining validity of an RFID tag comprising:
storing, in a reference database, a tag fingerprint including indicia of tag behavior indicative of a specific type of RFID tag, wherein the tag behavior comprises responses, from the tag, to a specific sequence of commands sent to the tag;
including the tag fingerprint in a digital signature performed over contents stored in a specific RFID tag;
reading a selected RFID tag; and
determining whether the selected RFID tag is a valid specific type of RFID tag by comparing the tag behavior of the selected tag with the indicia of tag behavior, for the specific type of RFID tag, stored in the reference database.

10. The method of claim 9, further comprising:
storing, in the reference database, a tag fingerprint including attributes for the specific type of RFID tag; and
determining whether the selected RFID tag is a valid specific type of RFID tag by comparing the tag fingerprint in the contents read from the selected RFID tag with the attributes, for the specific type of RFID tag, stored in the reference database.

11. The method of claim 10, wherein, when the step of comparing the tag fingerprint does not result in an exact match between the attributes being compared, then:
determining whether the selected RFID tag is a valid specific type of RFID tag based on a comparison of a predetermined threshold set of available attributes, read from the selected RFID tag, with the attributes, for the specific type of RFID tag, stored in the reference database.

12. The method of claim 11, wherein said attributes include at least one attribute selected from the list of attributes consisting of specific timing values for protocol actions, off-specification protocol actions, tag circuit impedance, responses to certain intentional error conditions, changes in said attributes based on tag communication frequency, and non-linear circuit characteristics of the tag.

13. A method for determining validity of an RFID tag comprising:
storing, in a reference database, a tag fingerprint including attributes for, and indicia of tag behavior indicative of, a specific type of RFID tag, wherein the tag behavior comprises responses, from the tag, to a specific sequence of commands sent to the tag;
including the tag fingerprint in a digital signature performed over contents stored in a specific RFID tag;
reading a selected RFID tag; and
determining whether the selected RFID tag is a valid specific type of RFID tag by:
comparing the tag fingerprint in the contents read from the selected RFID tag with the attributes, for the specific type of RFID tag, stored in the reference database; and
comparing the tag behavior of the selected tag with the indicia of tag behavior, for the specific type of RFID tag, stored in the reference database.

14. The method of claim 13, wherein, when neither of the comparing steps results in an exact match between the attributes being compared, then:
determining whether the selected RFID tag is a valid specific type of RFID tag based on a comparison of a predetermined threshold set of available attributes, read from the selected RFID tag, with the attributes, for the specific type of RFID tag, stored in the reference database.

15. The method of claim 14, wherein said attributes include at least one attribute selected from the list of attributes consisting of specific timing values for protocol actions, off-specification protocol actions, tag circuit impedance, responses to certain intentional error conditions, changes in said attributes based on tag communication frequency, and non-linear circuit characteristics of the tag.
